(19) United States
(12) Patent Application Publication
(10) Pub. No.: US 2010/0327816 A1
(43) Pub. Date: Dec. 30, 2010

(54) Intelligent Voltage and Current Controlled PWM Microcontroller Type Battery Charger

(76) Inventors: Ray CHIANG, Tainan City (TW); George Yen, Fongshan City (TW); Mars Tseng, Jiading Township (TW)

Correspondence Address: HDLS IPR Services, PO Box 220746, Chantilly, VA, 20153, US

(21) Appl. No.: 12/493,192

(22) Filed: Jun. 27, 2009

(51) Int. Cl. H02J 7/04

(52) U.S. Cl. 320/145

(57) ABSTRACT

An intelligent voltage and current controlled PWM microcontroller type battery charger includes an electromagnetic interference filter, a bridge rectifier, a transformer and a switching power supply of a rectifier as a main structure and operates with a microcontroller unit of a PWM controller for charging various chargeable batteries. The microcontroller unit operated with a battery charging protection block include a battery charging loop circuit connected to two PWM controllers for modulating outputs if constant voltage values and constant current values to control a feedback of the switching power supply. A current detection block, a voltage detection block and a temperature protection block are operated with the microcontroller unit. A battery charging protection block and a delay startup battery charging protection system are connected to the microcontroller unit. The invention can achieve the effects of charging different types of batteries, saving energy, reducing carbon and protecting environment.

### BACKGROUND OF THE INVENTION

1. Field of the Invention

The present invention relates to an intelligent voltage and current controlled pulse width modulation (PWM) microcontroller type battery charger that uses a microcontroller unit (MCU) and a PWM controller to modulate and produce voltages and currents at different levels for charging various different types of chargeable batteries (including lead-acid battery and lithium battery, etc) to meet the requirements of new-generation electric products.

2. Description of Related Art

Due to global warming and energy shortage, as well as the era of pursuing increasingly high requirement and price, energy saving and carbon reduction become a major trend of modern science and technologies, and thus products such as electric scooters, electric bike and electric car require a chargeable battery as a power source. With the fast-developing chargeable battery technologies, a single battery charger can no longer meet the specification and requirements of a variety of chargeable batteries anymore, and the chargeable battery cannot maximize its effect since most battery chargers available in the market are mainly designed for a specific chargeable battery only and cannot fit other types of chargeable batteries, and thus there is no battery charger capable of charging various different chargeable batteries available in the market so far. As a result, a consumer generally possesses several different types of battery chargers, not only incurring high cost and inconvenience to consumers, but also increasing the burden of environmental protection.

### SUMMARY OF THE INVENTION

Therefore, it is a primary objective of the present invention to provide an intelligent voltage and current controlled PWM microcontroller type battery charger, and the battery charger comprises a pulse width modulation (PWM) controller installed at a microcontroller unit (MCU) and connected to a temperature protection block and a switching power supply, such that the microcontroller can control the operation of the whole circuit and output signals to instruct two PWM controllers to control the output voltage/current of the battery charger, and also control the voltage/current of various different chargeable batteries in a battery charge, so as to provide higher flexibility and achieve the economic beneficial effect of energy saving and environmental protection.

### BRIEF DESCRIPTION OF THE DRAWINGS

The invention, as well as its many advantages, may be further understood by the following detailed description and drawings in which:

FIG. 1 is a schematic view showing a structure of a battery charger in accordance with the present invention;

FIG. 2 shows a first part of a flow chart of charging a lead-acid battery by a battery charger in accordance with the present invention;

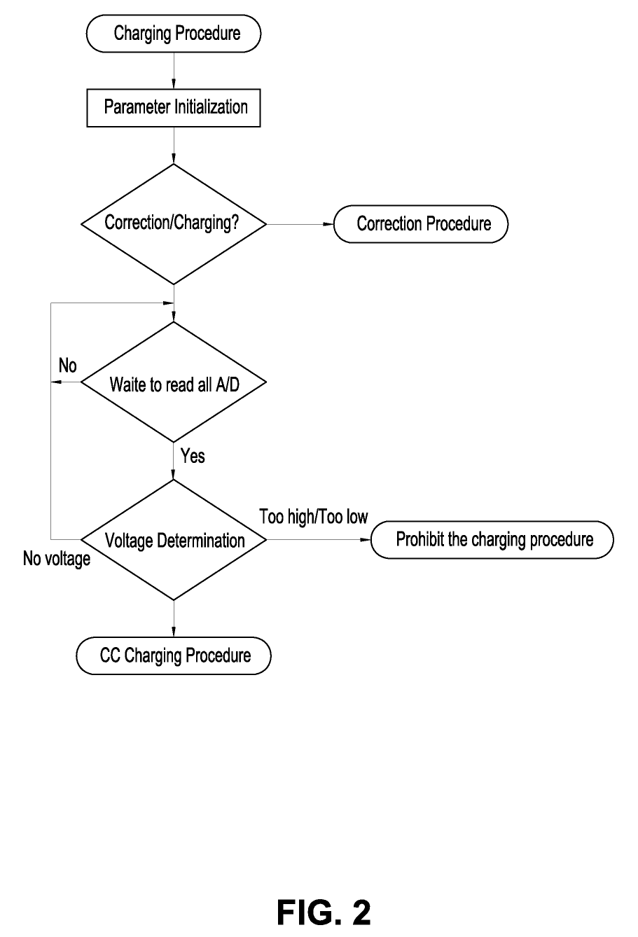

FIG. 3 shows a second part of a flow chart of charging a lead-acid battery by a battery charger in accordance with the present invention;

FIG. 4 shows a third part of a flow chart of charging a lead-acid battery by a battery charger in accordance with the present invention;

FIG. 5 shows a flow chart of charging a lead-acid battery by a battery charger with a temperature protection block in accordance with the present invention.

### DETAILED DESCRIPTION OF THE INVENTION

The technical characteristics of the present invention will now be described in more detail hereinafter with reference to the accompanying drawings that show various preferred embodiments of the invention as follows.

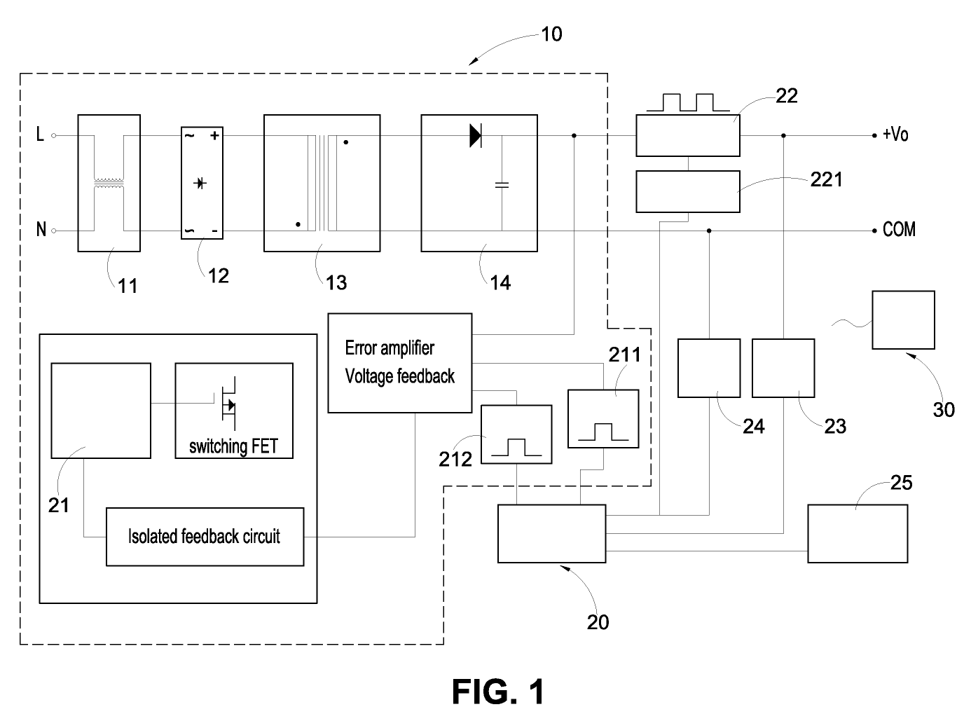

With reference to FIG. 1 for a schematic view showing a structure of a battery charger in accordance with the present invention, the battery charger comprises an electromagnetic interference filter 11, a bridge rectifier 12, a transformer 13 and a switching power supply (SPS) 10 of a rectifier 14 as the main structure and operates with a PWM microcontroller unit 20 comprising a PWM controller 21 and a microcontroller unit (MCU) for detecting the conditions of different types of chargeable batteries 30 (such as lead-acid, nickel-hydrogen (Ni—H), nickel-cadmium (Ni—Cd) and lithium (Li) batteries) and controlling the conditions of charging the switching power supply 10, wherein the microcontroller unit 20 operates with a battery charging protection block 22 for electrically conducting a battery charging loop circuit, and includes a voltage detection block 23, a current detection block 24 and a temperature protection block 25 to operate with the microcontroller unit 20 for detecting whether or not the voltage value of a chargeable battery 30 is too high, whether or not the current of the chargeable battery 30 has reached a transition point to enter into a next-stage charging process and whether or not the temperature of the battery charger is abnormal, and returning related data or information to the microcontroller unit 20. The microcontroller unit 20 is coupled to two PWM controllers 21 for modulating the outputs of constant voltage (CV) values 211 and constant current (CC) values 212 to control the feedback of the switching power supply 10, so that the PWM controller 21 can modulate the output voltage of the switching power supply 10 to an appropriate constant voltage (CV) value 211 and an appropriate constant current (CC) value 212 without requiring additional hardware devices, and this arrangement provides more flexibility and better competitiveness to applications and developments of the battery charger. The battery charging protection block 22 continues receiving a CLOCK signal from the microcontroller unit 20 to instruct the battery charging loop circuit to be set to an ON state, and the voltage value of the battery charger electrically conducts the battery charging loop circuit through the battery charging protection block 22 and charges the chargeable battery 30. If the microcontroller unit 20 is situated at an out-of-control state and unable to continue transmitting the CLOCK signal to the battery charging protection block 22, the battery charging loop circuit will bet turned to an OFF state to achieve the effect of protecting the battery charger. If the microcontroller unit 20 is maintained at a high electric potential or a low potential continuously, then the battery charging protection block 22 will be unable to conduct the battery charging loop circuit to be set to the ON state. The battery charging protection block 22 includes a delay startup battery charging protection system 221 and is connected to the battery charging loop circuit, such that if the microcontroller unit 20 detects the existence of a chargeable battery 30, the delay startup battery charging protection system 221 will enable a 3-second delay to assure that the chargeable battery 30 is connected properly with the battery charger before the battery charge takes place, so as to protect the usage of the battery charger.

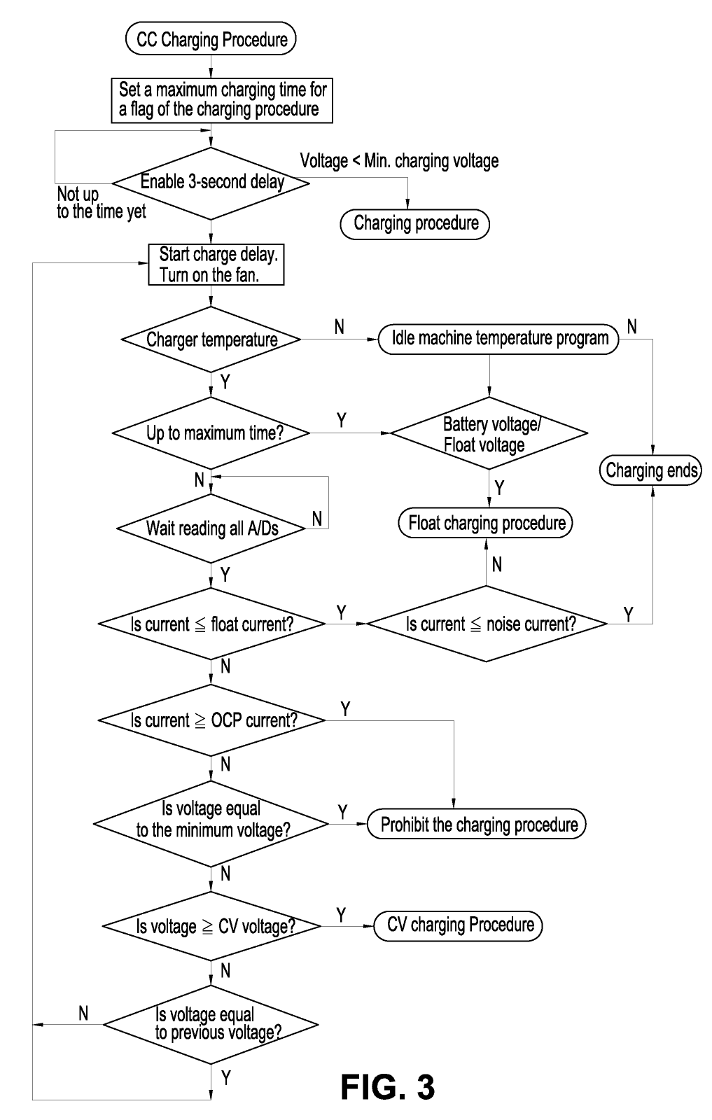

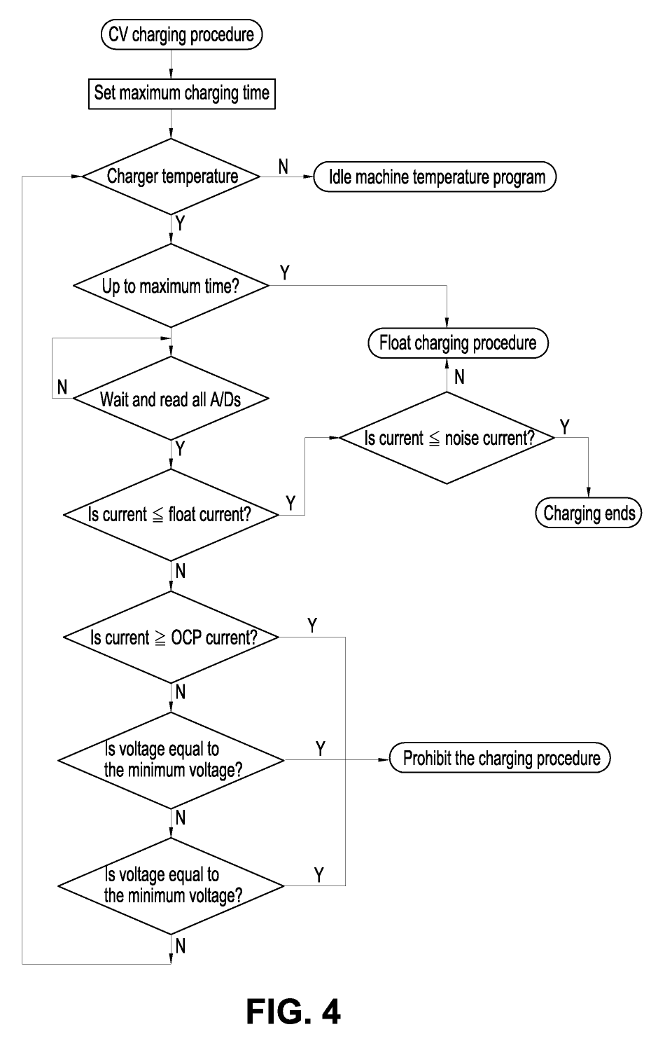

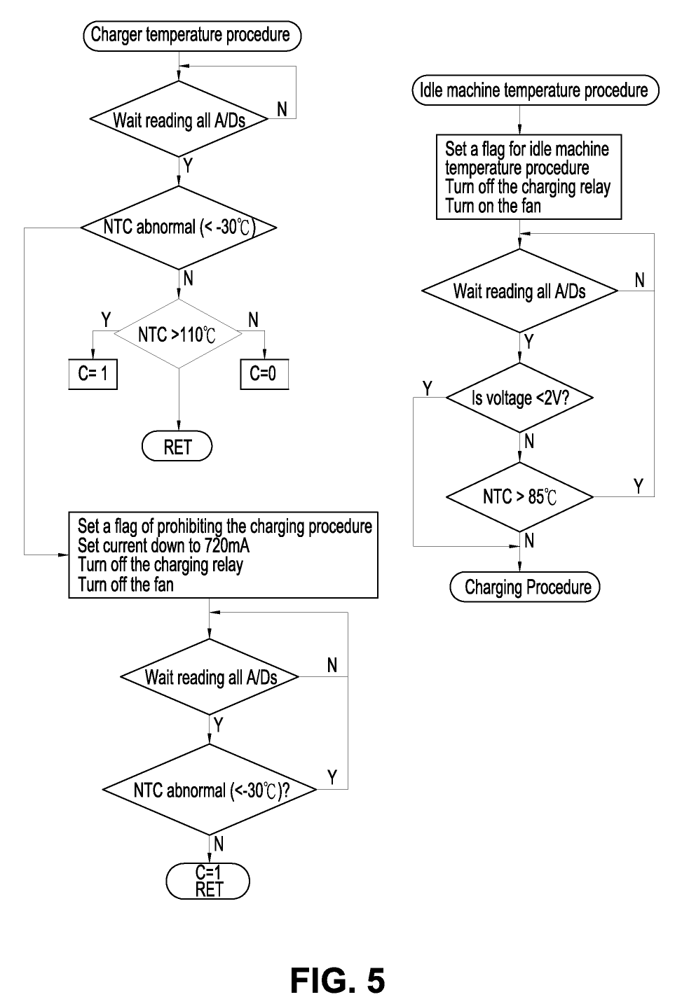

With reference to FIGS. 3 and 4 for a flow chart of charging a lead-acid battery by a battery charger in accordance with the present invention, the lead-acid battery is placed into the battery charger of the switching power supply 10, and the microcontroller unit 20 starts initializing parameters and a correction procedure, while reading all voltage values of an A/D converter, and the battery charging protection block 22 will not drive the battery charging loop circuit to be set to the ON state if the microcontroller unit 20 continuously reads a high potential or a low potential, so as to achieve the protection control function. If the microcontroller unit 20 keeps transmitting CLOCK signals, the battery charging protection block 22 will electrically conduct the battery charging loop circuit into the ON state and enter into the battery charging procedure with a constant voltage (CV) value 211. According to the maximum charging time, a flag is set for charging the lead-acid battery with predetermined voltage/current values, and the delay startup battery charging protection system 221 is enabled to start charging the battery at normal conditions. In the meantime, the voltage detection block 23 and the current detection block 24 of the microcontroller unit 20 are provided for detecting the voltage/current values of the lead-acid battery first and then modulating the output of the PWM controller 21 according to the constant voltage (CV) value 211 to charge the lead-acid battery 30′ with the predetermined voltage/current values. If voltage≧constant current (CC) value 212, then the battery charger will enter into the charging procedure with a constant current (CC) value 212. In the lead-acid battery, if voltage>float voltage, and current≦noise current, then the charging procedure will end. With reference to FIG. 5 for a flow chart of charging a lead-acid battery by a battery charger having a temperature protection block in accordance with the present invention, the battery charger enters into a temperature protection procedure during the battery charge to assure that the temperature protection block 25 can be maintained at a room temperature, and the microcontroller unit 20 is provided for controlling the whole circuit operation and operated with the PWM controller 21 to give an advantageous design of modulating a voltage output and controlling a current output in order to improve the shortcomings of the traditional battery charger that is designed for charging a particular chargeable battery only, and thus the invention can be applied to all kinds of electric scooters, electric bikes, and electric devices that require a battery charger for charging a battery. In addition, the present invention can achieve the effects of saving energy, reducing carbon, protecting environment, as well as protecting and controlling the chargeable battery 30 before and during the battery charging process to assure the safety of use.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. An intelligent voltage and current controlled PWM microcontroller type battery charger, comprising an electromagnetic interference filter, a bridge rectifier, a transformer and a switching power supply of a rectifier as a main structure operated with a microcontroller unit of a pulse width modulation (PWM) controller for charging various different chargeable batteries, and the microcontroller unit operating with a battery charging protection block having a battery charging loop circuit connected to two PWM controllers for controlling, modulating, and outputting constant voltage (CV) values and constant current (CC) values at different levels to control a feedback of the switching power supply, and including a current detection block, a voltage detection block and a temperature protection block operated with the microcontroller unit for detecting whether or not the voltage value of the chargeable battery is too high, whether or not the current of the chargeable battery has reached a transition state and it is necessary to enter into a next-stage charging process, and whether or not the temperature of the battery charger is abnormal, and returning related information and data to the microcontroller unit, wherein the microcontroller unit drives the battery charging protection block to keep receiving a signal from the microcontroller unit for instructing the battery charging loop circuit to be set to an ON state, so that a voltage value of the battery charger is provided for charging the chargeable battery through the battery charging protection block, and if the microcontroller unit is situated at an out-of-control state, and the microcontroller will be unable to keep transmitting signals to the battery charging protection block, then the battery charging loop circuit will be set to an OFF state, so as to achieve the effect of protecting the battery charging loop circuit, and if the microcontroller unit is maintained at a high potential or a low potential continuously, then the microcontroller will be unable to drive the battery charging loop circuit into the ON state, and the battery charging protection block is connected to a delay startup battery charging protection system, so that if the microcontroller unit detects an external chargeable battery placed in the battery charger, then the delay startup battery charging protection system will start a delay time to assure the safety of a battery charging process.
